(19) United States
(12) Patent Application Publication
(10) Pub. No.: US 2007/0067415 A1
(43) Pub. Date: Mar. 22, 2007

(54) In-vehicle display apparatus and in-vehicle proxy server for use therewith

(76) Inventor: Shuichi Kawaguchi, Fujisawa-city (JP)

Correspondence Address: BRINKS HOFER GILSON & LIONE, P.O. BOX 10395, CHICAGO, IL, 60610, US

(21) Appl. No.: 11/524,086

(22) Filed: Sep. 20, 2006

(30) Foreign Application Priority Data
Sep. 22, 2005 (JP) 2005-275170

(51) Int. Cl. G06F 15/16

(52) U.S. Cl. 709/217

(57) ABSTRACT

In an in-vehicle display apparatus and an in-vehicle proxy server operating in cooperation with the in-vehicle display apparatus, the in-vehicle proxy server modifies a content acquired from a server in accordance with vehicle running state information provided from an information providing unit such that a description specifying a linked content including display information not wanted or not necessary to be displayed on a display unit in the current vehicle running state is deleted from the content, and the in-vehicle proxy server supplies the resultant modified content to the browser. In accordance with the modified content supplied from the in-vehicle proxy server, the browser does not request the linked content including display information not wanted or not necessary to be displayed on the display unit.

### RELATED APPLICATIONS

The present application claims priority to Japanese Patent Application Serial Number 2005-275170, filed on Sep. 22, 2005, the entirety of which is hereby incorporated by reference.

### BACKGROUND OF THE INVENTION

1. Field of the Invention

The present invention relates to an in-vehicle display apparatus and an in-vehicle proxy server for use therewith, and more particularly, to an in-vehicle display apparatus suitably adapted to display information on a display unit by a browser disposed in a vehicle and an in-vehicle proxy server for use therewith.

2. Description of the Related Art

In a conventional in-vehicle apparatus (such as an in-vehicle navigation apparatus) having an in-vehicle display apparatus, an HTML (Hyper Text Markup Language) browser is used.

The HTML browser is software that allows a content described in HTML to be displayed.

The HTML browser has various functions including interpreting a layout or color described in an HTML content, acquiring a file needed to display a still image or a moving image described in the HTML content, and reproducing information such as text, a still image or a moving image in a layout and a color specified by the HTML content and displaying the reproduced information.

The HTML content may reside in a storage device disposed in the in-vehicle apparatus or may reside on a World Wide Web server on the Internet (hereinafter referred to simply as a Web server) outside the in-vehicle apparatus.

When a user of the in-vehicle apparatus uses an HTML content on the Internet, the user accesses the Web server to acquire the HTML content residing on the Web server via data communication using a portable telephone or the like.

Conventionally, when the Internet is used, a proxy server is generally installed between a Web server and a client.

The proxy server controls a data cache so as to reduce a communication load and controls accessing in accordance with settings made by a system manager. (A further detailed description of the conventional technique will be found, for example, in Japanese Unexamined Patent Application Publication No. 2003-44517.)

In the conventional technique, a HTML content residing on a Web server is directly played back using a HTML browser installed in an in-vehicle apparatus. This causes a problem that it is impossible to control the display of information in a manner desirable for the in-vehicle apparatus. Specific examples of problems are as follows

### FIRST EXAMPLE

### Problem in Playback of Moving Image When a Vehicle is Running

In an in-vehicle apparatus, to secure safety, it is generally required to disable displaying moving images when a vehicle is running.

However, the conventional HTML browser operates such that if a HTML content includes a description specifying a moving image file, the in-vehicle apparatus downloads the specified moving image file and displays the downloaded moving image file regardless of whether the vehicle is running or not.

### SECOND EXAMPLE

### Problem with Color

In the in-vehicle apparatus, in order to secure safety, it is necessary to control the color of display information such as characters and still/moving images included in or linked to an HTML content depending upon the lightness or illumination inside/outside of the vehicle.

However, in many HTML contents, there is no consideration about the control of colors depending upon the lightness inside/outside of the vehicle. Besides, many HTML contents are produced without assuming that they may be displayed in a vehicle. The HTML browser for use in a vehicle is generally designed such that information is displayed without taking into account the lightness in the inside/outside of the vehicle.

For example, information is displayed in a very bright color even in a dark environment, which may occur at night.

### THIRD EXAMPLE

### Problem with Screen Size

The screen size of the in-vehicle apparatus is smaller than that of a display designed for use with a personal computer, and the screen size varies from one type of in-vehicle apparatus to another. Many HTML contents are designed in terms of the layout assuming that the contents are displayed on a screen of a personal computer. If such an HTML content is displayed on a small-size screen of an in-vehicle apparatus, there can occur a problem that not all characters are displayed on the screen with the limited size or deformation occurs in the form of the content.

The above-described problem can be solved if the content is designed assuming that it is displayed on a small-size screen of an in-vehicle apparatus. However, in this case, a content provider or a Web server has to prepare many forms for each content so that the content can be properly displayed not only on a computer screen but also on screens with different sizes of various types of in-vehicle apparatus. This imposes a great load on the content provider or the Web server.

### FOURTH EXAMPLE

### Communication Failure Risk

When the in-vehicle apparatus acquires an HTML content to be displayed on the HTML browser via a network, mobile communication means such as a portable telephone is used as communication means for connection to the network.

Such mobile communication means is low in processing speed as compared to a personal computer or the like, and use of radio waves results in low connection reliability. When the mobile communication means is used in a running vehicle, the state of radio waves changes as the vehicle runs, and thus connection is unstable. Furthermore, because there is no restriction on the data size of the contents and it is impossible to know the data size until a Web server is accessed, there is a possibility that unexpectedly high communication cost is spent to acquire the content. This problem is serious in particular when the communication fee is charged based on a measured rate.

The above problem becomes more serious in a case in which a file acquired by the in-vehicle apparatus turns out to be unusable by the in-vehicle apparatus after the file was actually acquired.

### FIFTH EXAMPLE

### Problem with Design Modification

HTML browsers for general use are designed according to specifications established by W3C (World Wide Web Consortium).

At present, to adapt the HTML browser to the in-vehicle apparatus, it is necessary to design the HTML browser such that the HTML browser has a display function that meets the requirement for use on the in-vehicle apparatus (such that no moving image is displayed when the vehicle is running, information is displayed in a color adapted to the lightness inside/outside of the vehicle, and information is displayed in a layout adapted to the screen size of the in-vehicle apparatus). However, such modification in the design of the HTML browser needs a high labor cost.

In the conventional technique, because of the problems described above with reference to specific examples (first to fifth Examples), it is impossible to properly control displaying of information in a manner required for the in-vehicle apparatus.

### SUMMARY OF THE INVENTION

In view of the above, it is an object of the present invention to provide an in-vehicle display apparatus and an in-vehicle proxy server capable of properly controlling displaying of information in a manner required for an in-vehicle apparatus.

According to an aspect of the present invention, to achieve the above object, there is provided an in-vehicle display apparatus comprising an in-vehicle proxy server for acquiring a content provided from a server in response to a request for the content issued by a browser, and an information providing unit for providing information indicating a running state of a vehicle to the in-vehicle proxy server, the in-vehicle proxy server being configured such that the in-vehicle proxy server modifies the content acquired from the server such that in accordance with the information indicating the running state of the vehicle supplied from the information providing unit, any description specifying a linked content including display information not wanted or unnecessary to be displayed on a display unit in the current vehicle running state is deleted from the content, and the in-vehicle proxy server supplies the resultant modified content to the browser, the browser being configured not to request the linked content including the unwanted or unnecessary display information in accordance with the modified content supplied from the in-vehicle proxy server.

In this in-vehicle display apparatus configured in the above-described manner, the in-vehicle proxy server modifies the content in accordance with the information indicating the running state of the vehicle provided from the information providing unit, thereby preventing the browser from requesting a linked content including unwanted or unnecessary display information. This ensures that display information which is not wanted or not necessary to be displayed in the current vehicle running state is prevented from being displayed.

According to another aspect of the present invention, there is provided an in-vehicle display apparatus configured such that when vehicle running state information provided from an information providing unit to an in-vehicle proxy server indicates that the vehicle is currently running, the in-vehicle proxy server modifies a content acquired from a server such that a description specifying a linked content including image information not wanted or not necessary to be displayed on a display unit is deleted from the content, and, in accordance with the modified content supplied from the in-vehicle proxy server, the browser does not request the linked content including the image information.

In this in-vehicle display apparatus configured in the above-described manner, the in-vehicle proxy server modifies the content in accordance with the information indicating the running state of the vehicle provided from the information providing unit, thereby preventing the browser from requesting a linked content including image information, and thus ensuring that no image is displayed when the vehicle is running.

According to another aspect of the present invention, there is provided an in-vehicle display apparatus configured such that when vehicle running state information supplied from an information providing unit to an in-vehicle proxy server indicates that the vehicle is currently running at a speed higher than a predetermined speed, the in-vehicle proxy server modifies the content acquired from the server such that a description specifying a linked content including image information not wanted or not necessary to be displayed is deleted from the content, the in-vehicle proxy server supplies the resultant modified content to a browser, and, in accordance with the modified content supplied from the in-vehicle proxy server, the browser does not request the linked content including the image information.

In this in-vehicle display apparatus configured in the above-described manner, the in-vehicle proxy server modifies the content depending on whether the information provided from the information providing unit indicates that the vehicle is currently running at a speed higher than the predetermined speed, thereby preventing the browser from requesting a linked content including image information and thus ensuring that no image is displayed when the vehicle is running at a speed higher than the predetermined speed.

In the in-vehicle display apparatus configured in the above-described manner, the image information may be moving image information. This ensures that no moving image is displayed when the vehicle is running or when the running speed is higher than the predetermined speed.

According to another aspect of the present invention, there is provided an in-vehicle display apparatus configured such that an in-vehicle proxy server is applied to both a browser located in a driver's seat area to display information on a display located in the driver's seat area and a browser located in a rear seat area to display information on a display located in the rear seat area, and such that the in-vehicle proxy server is allowed to supply a content including a description specifying a linked content including image information to the browser located in the rear seat area even when the vehicle is currently running thereby allowing the browser in the rear seat area to request the linked content including the image information and display the image information on the display located in the rear seat area even when the vehicle is currently running.

This in-vehicle display apparatus configured in the above-described manner makes it possible to realize a rear entertainment system in which an image is allowed to be displayed on a display located in a rear seat area without concern for safety even when the vehicle is running.

According to another aspect of the present invention, there is provided an in-vehicle display apparatus configured such that an in-vehicle proxy server is applied to both a browser located in a driver's seat area to display information on a display located in the driver's seat area and a browser located in a rear seat area to display information on a display located in the rear seat area. The in-vehicle proxy server is allowed to supply a content including a description specifying a linked content including image information to the browser located in the rear seat area even when the vehicle is running at a speed higher than the predetermined speed thereby allowing the browser in the rear seat area to request the linked content including the image information and display the image information on the display located in the rear seat area even when the vehicle is running at the speed higher than the predetermined speed.

This in-vehicle display apparatus configured in the above-described manner makes it possible to realize a rear entertainment system in which an image is allowed to be displayed on a display located in a rear seat area without concern for safety even when the vehicle is running at a speed higher than the predetermined speed.

According to another aspect of the present invention, there is provided an in-vehicle display apparatus comprising an in-vehicle proxy server for acquiring a content provided from a server in response to a request for the content issued by a browser, and an information providing unit for supplying information indicating lightness inside and/or outside of a vehicle and information indicating a display color corresponding to the lightness inside and/or outside of the vehicle, wherein the in-vehicle proxy server is configured such that the in-vehicle proxy server modifies the content acquired from the server such that the display color of the display information is changed to the display color corresponding to the lightness inside and/or outside of the vehicle, and the in-vehicle proxy server supplies the resultant modified content to the browser, and wherein the browser is configured to display the display information in the changed display color on a display unit in accordance with the modified content supplied from the in-vehicle proxy server.

In this in-vehicle display apparatus configured in the above-described manner, the in-vehicle proxy server modifies the content in accordance with the information in terms of the lightness inside and/or outside of the vehicle and the display color corresponding to the lightness inside and/or outside of the vehicle provided from the information providing unit, thereby allowing the browser to display on the display unit the display information in the display color adapted to the lightness inside and/or outside of the vehicle.

In this in-vehicle display apparatus configured in the above-described manner, the display color indicated by the information indicating the display color corresponding to the lightness inside and/or outside of the vehicle may become darker as the lightness inside and/or outside of the vehicle becomes darker.

This makes it possible to display the display information in a darker display color as the lightness inside and/or outside of the vehicle becomes darker.

In the in-vehicle display apparatus configured in the above-described manner, the information indicating the lightness inside and/or outside of the vehicle provided from the information providing unit to the in-vehicle proxy server may be information generated based upon a parking light signal.

This makes it possible for the information providing unit to surely and easily provide the information indicating the lightness inside and/or outside of the vehicle to the in-vehicle proxy server.

According to another aspect of the present invention, there is provided an in-vehicle display apparatus comprising an in-vehicle proxy server for acquiring a content provided from a server in response to a request for the content issued by a browser, and an information providing unit for providing information indicating the screen size of a display unit to the in-vehicle proxy server, wherein the in-vehicle proxy server is configured such that the in-vehicle proxy server modifies the content acquired from the server such that the layout of the display information is changed to a layout adapted to the screen size of the display unit in accordance with the information indicating the screen size provided from the information providing unit, and the in-vehicle proxy server supplies the resultant modified content to the browser, and wherein the browser is configured to display the display information in the changed layout on the display unit in accordance with the modified content supplied from the in-vehicle proxy server.

In this in-vehicle display apparatus configured in the above-described manner, the in-vehicle proxy server modifies the content in accordance with the information indicating the screen size of the display unit provided from the information providing unit thereby allowing the browser to display the display information in the layout adapted to the screen size of the display unit.

According to another aspect of the present invention, there is provided an in-vehicle display apparatus comprising an in-vehicle proxy server for acquiring a content provided from a server in response to a request for the content issued by a browser, and an information providing unit for providing information indicating a running state of a vehicle to the in-vehicle proxy server, wherein the in-vehicle proxy server is configured such that when the information indicating the running state of the vehicle supplied from the information providing unit indicates that the vehicle is currently running, the in-vehicle proxy server modifies the content supplied from the server such that a character size of display information is increased so as to be greater than a character size for use in a state in which the vehicle is at rest, and the in-vehicle proxy server supplies the resultant modified content to the browser, and wherein the browser is configured to display on a display the display information in the character size increased so as to be greater than the character size for use in the state in which the vehicle is at rest in accordance with the modified content supplied from the in-vehicle proxy server.

In this in-vehicle display apparatus configured in the above-described manner, the in-vehicle proxy server modifies the content in accordance with the information indicating the running state of the vehicle provided from the information providing unit, thereby allowing the browser to display the display information in the greater character size than the character size for use in the state in which the vehicle is at rest.

In the in-vehicle display apparatus, the information indicating the running state of the vehicle provided from the information providing unit to the in-vehicle proxy server may be information generated based on at least one of a vehicle speed pulse signal and a parking brake signal.

This makes it possible for the information providing unit to surely and easily provide the information indicating the running state of the vehicle to the in-vehicle proxy server.

According to another aspect of the present invention, there is provided an in-vehicle display apparatus comprising an in-vehicle proxy server for acquiring a content provided from a server in response to a request for the content issued by a browser, and an information providing unit for providing information indicating a type of information acceptable by the in-vehicle display apparatus to the in-vehicle proxy server, wherein the in-vehicle proxy server is configured such that the in-vehicle proxy server modifies the content acquired from the server such that any description specifying a linked content including information of a type unacceptable by the in-vehicle display apparatus is deleted from the content in accordance with the acquired information indicating the type of information acceptable by the in-vehicle display apparatus, and the in-vehicle proxy server supplies the resultant modified content to the browser, and wherein the browser is configured not to request the linked content including the information of the type unacceptable by the in-vehicle display apparatus in accordance with the modified content supplied from the in-vehicle proxy server.

In this in-vehicle display apparatus configured in the above-described manner, the in-vehicle proxy server modifies the content in accordance with the information indicating the information type acceptable by the in-vehicle display apparatus provided from the information providing unit thereby preventing the browser from requesting the linked content including information unacceptable by the in-vehicle display apparatus and thus ensuring that information including unacceptable information is not acquired.

According to another aspect of the present invention, there is provided an in-vehicle proxy server configured such that the in-vehicle proxy server is capable of acquiring information indicating a running state of a vehicle, and modifying a content acquired from a server such that in accordance with the information indicating the running state of the vehicle, any description specifying a linked content including display information unnecessary to be displayed on a display unit in the current vehicle running state is deleted from the content, supplying the resultant modified content to the browser thereby preventing the browser from requesting the linked content including the display information unnecessary to be displayed on the display unit.

In this in-vehicle proxy server configured in the above-described manner, the content is modified in accordance with the information indicating the running state of the vehicle thereby preventing the browser from requesting a linked content including display information unnecessary to be displayed on the display unit. This ensures that display information unnecessary to be displayed in the current vehicle running state is prevented from being displayed.

According to another aspect of the present invention, there is provided an in-vehicle proxy server configured such that when acquired vehicle running state information indicates that the vehicle is currently running, the in-vehicle proxy server modifies a content acquired from a server such that a description specifying a linked content including image information as the display information unnecessary to be displayed on a display unit is deleted from the content, thereby preventing a browser from requesting the linked content including the image information.

In this in-vehicle proxy server configured in the above-described manner, the content is modified in accordance with the vehicle running state information thereby preventing the browser from requesting the linked content including the image information and thus ensuring that no image is displayed when the vehicle is running.

According to another aspect of the present invention, there is provided an in-vehicle proxy server configured such that when the in-vehicle proxy server acquires information indicating that a vehicle is currently running at a speed higher than a predetermined speed, the in-vehicle proxy server modifies a content acquired from a server such that a description specifying a linked content including image information as the display information unnecessary to be displayed on a display unit is deleted from the content and the in-vehicle proxy server supplies the resultant modified content to the browser thereby preventing the browser from requesting the linked content including the image information.

In this in-vehicle proxy server configured in the above-described manner, the content is modified in accordance with the vehicle running state information indicating whether the vehicle is running at a speed higher than the predetermined speed thereby preventing the browser from requesting a linked content including image information and thus ensuring that no image is displayed when the vehicle is running at a speed higher than the predetermined speed.

In the in-vehicle proxy server, the image information may be moving image information.

In this in-vehicle proxy server, it is ensured that no image is displayed when the vehicle is running at a speed higher than the predetermined speed.

According to another aspect of the present invention, there is provided an in-vehicle proxy server configured such that the in-vehicle proxy server is applied to both a browser located in a driver's seat area to display information on a display located in the driver's seat area and a browser located in a rear seat area to display information on a display located in the rear seat area, and such that the in-vehicle proxy server is allowed to supply a content including a description specifying a linked content including image information to the browser located in the rear seat area even when the vehicle is currently running, thereby allowing the browser to request the linked content including the image information and display the image information on the display located in the rear seat area.

This in-vehicle proxy server configured in the above-described manner makes it possible to realize a rear entertainment system in which an image is allowed to be displayed on a display located in a rear seat area without concern for safety even when the vehicle is running.

According to another aspect of the present invention, there is provided an in-vehicle proxy server configured such that the in-vehicle proxy server is applied to both a browser located in a driver's seat area to display information on a display located in the driver's seat area and a browser located in a rear seat area to display information on a display located in the rear seat area. The in-vehicle proxy server is allowed to supply a content including a description specifying a linked content including image information to the browser located in the rear seat area even when the vehicle is currently running at a speed higher than the predetermined speed, thereby allowing the browser to request the linked content including the image information and display the image information on the display located in the rear seat area.

This in-vehicle proxy server configured in the above-described manner makes it possible to realize a rear entertainment system in which an image is allowed to be displayed on a display located in a rear seat area without concern for safety even when the vehicle is running at a speed higher than the predetermined speed.

According to another aspect of the present invention, there is provided an in-vehicle proxy server configured such that the in-vehicle proxy server is capable of acquiring information indicating lightness inside and/or outside of a vehicle and information indicating a display color corresponding to the lightness inside and/or outside of the vehicle, modifying a content acquired from a sever such that the display color of display information is changed to the display color corresponding to the lightness inside and/or outside of the vehicle in accordance with the information indicating the lightness inside and/or outside of the vehicle and the information indicating the display color corresponding to the lightness inside and/or outside of the vehicle, and supplying the resultant modified content to the browser thereby allowing the browser to display the display information in the changed display color on the display unit.

In this in-vehicle proxy server configured in the above-described manner, the content is modified in accordance with the information indicating the lightness inside and/or outside of the vehicle, thereby allowing the browser to display the display information in a display color adapted to the lightness inside and/or outside of the vehicle becomes darker.

In the in-vehicle proxy server, the display color indicated by the information indicating the display color corresponding to the lightness inside and/or outside of the vehicle may become darker as the lightness inside and/or outside of the vehicle becomes darker.

This makes it possible to display the display information in a darker display color as the lightness inside and/or outside of the vehicle becomes darker.

In the in-vehicle proxy server, the information indicating the lightness inside and/or outside of the vehicle may be information generated based on a parking light signal.

This makes it possible to surely and easily acquire the information indicating the lightness inside and/or outside of the vehicle to the in-vehicle proxy server.

According to another aspect of the present invention, there is provided an in-vehicle proxy server configured such that the in-vehicle proxy server is capable of acquiring information indicating the screen of a display unit modifying a content acquired from a server such that the layout of display information is changed to a layout adapted to the screen size of the display unit in accordance with the acquired information indicating the screen size, supplying the resultant modified content to the browser thereby allowing the browser to display the display information in the changed layout on the display unit.

In this in-vehicle proxy server configured in the above-described manner, the content is modified in accordance with the information indicating the screen size of the display unit thereby allowing the browser to display on the display unit the display information in the layout adapted to the screen size of the display unit.

According to another aspect of the present invention, there is provided an in-vehicle proxy server configured such that the in-vehicle proxy server is capable of acquiring information indicating a running state of a vehicle, and such that when the acquired vehicle running state information indicates that the vehicle is currently running, the in-vehicle proxy server modifies a content supplied from a server such that a character size of display information is increased so as to be greater than a character size for use in a state in which the vehicle is at rest, and supplies the resultant modified content to the browser thereby allowing the browser to display the display information in the character size changed so as to be greater than the character size for use in the state in which the vehicle is at rest.

In this in-vehicle proxy server configured in the above-described manner, the content is modified in accordance with the vehicle running state information thereby allowing the browser to display the display information in the character size changed so as to be greater than the character size for use in the state in which the vehicle is at rest.

In the in-vehicle proxy server, the information indicating the running state of the vehicle may be information generated based on at least one of a vehicle speed pulse signal and a parking brake signal.

This makes it possible to surely and easily acquire the information indicating the running state of the vehicle to the in-vehicle proxy server.

According to another aspect of the present invention, there is provided an in-vehicle proxy server configured such that the in-vehicle proxy server is capable of acquiring information indicating a type of information acceptable by the in-vehicle display apparatus, modifying a content acquired from a server such that any description specifying a linked content including information of a type unacceptable by the in-vehicle display apparatus is deleted from the content in accordance with the acquired information indicating the type of information acceptable by the in-vehicle display apparatus, and supplying the resultant modified content to the browser thereby preventing the browser from requesting the linked content including the information of the type unacceptable by the in-vehicle display apparatus.

In this in-vehicle proxy server configured in the above-described manner, the content is modified in accordance with the information indicating the information type acceptable by the in-vehicle display apparatus thereby preventing the browser from requesting the linked content including display information unacceptable by the in-vehicle display apparatus. This ensures that display information of the unacceptable type is not acquired.

The present invention provides advantages as described below.

In the in-vehicle display apparatus and the in-vehicle proxy server according to the present invention, a content is modified in accordance with the information indicating the vehicle running state information so that display information unnecessary to be displayed in the current vehicle running state is not displayed. That is, to meet the requirement specific to the in-vehicle apparatus, the display of information is controlled so as not to display information which should not be displayed in the state in which the vehicle is running. Because the modification of contents is made by the in-vehicle proxy server, there is no particular restriction on the type of contents (for example, HTML contents designed to be displayed on a personal computer may be used), and thus high versatility in terms of the information type is achieved. Furthermore, because information (moving image information) which is not displayed is not acquired, it is possible to prevent cost from being spent for useless communication. Furthermore, a common browser (such as that designed according to the HTML specifications established by W3C) can be used without having to make a particular design modification to adapt to in-vehicle apparatus. This allows further high versatility to be achieved.

In the in-vehicle display apparatus and the in-vehicle proxy server according to the present invention, a content is modified in accordance with the vehicle running state information so as to prevent an image from being displayed when the vehicle is running. That is, it is possible to properly control the display of information such that for the purpose of safety, no image is displayed when the vehicle is running, which is a requirement specific to the in-vehicle apparatus, without having to use a special content or a special browser. Furthermore, because acquisition is not performed for image information which is not displayed in the state in which the vehicle is running, it is possible to prevent cost from being spent for useless communication.

In the in-vehicle display apparatus and the in-vehicle proxy server according to the present invention, a content is modified in accordance with the vehicle running state information indicating whether the vehicle is running at a speed higher than the predetermined speed thereby ensuring that no image is displayed when the vehicle is running at a speed higher than the predetermined speed. That is, it is possible to properly control the display of information such that for the purpose of safety, no image is displayed when the vehicle is running at a speed higher than the predetermined speed, which is a requirement specific to the in-vehicle apparatus, without having to use a special content or a special browser. Furthermore, because acquisition is not performed for image information which is not displayed in the state in which the vehicle is running at a speed higher than the predetermined speed, it is possible to prevent cost from being spent for useless communication.

In the in-vehicle display apparatus and the in-vehicle proxy server according to the present invention, it is ensured that no image is displayed when the vehicle is running or when the vehicle is running at a speed higher than the predetermined speed. That is, it is possible to properly control the display of information such that for the purpose of safety, no image is displayed when the vehicle is running or when the vehicle is running at a speed higher than the predetermined speed, which is a requirement specific to the in-vehicle apparatus, without having to use a special content or a special browser. Furthermore, because acquisition is not performed for image information which is not displayed when the vehicle is running or when the vehicle is running at a speed higher than the predetermined speed, it is possible to prevent cost from being spent for useless communication.

In the in-vehicle display apparatus and the in-vehicle proxy server according to the present invention, it is possible to realize a rear entertainment system in which an image is allowed to be displayed on a display located in a rear seat area without concern for safety even when the vehicle is running.

In the in-vehicle display apparatus and the in-vehicle proxy server according to the present invention, it is possible to realize a rear entertainment system in which an image is allowed to be displayed on a display located in a rear seat area without concern for safety even when the vehicle is running at a speed higher than the predetermined speed.

In the in-vehicle display apparatus and the in-vehicle proxy server according to the present invention, a content is modified in accordance with information indicating the lightness inside and/or outside of the vehicle and information indicating a display color corresponding to the lightness inside/or outside of the vehicle, thereby allowing display information to be displayed in the display color adapted to the lightness inside and/or outside of the vehicle. That is, it is possible to properly control the display of information such that display information is displayed in a display color adapted to the lightness inside and/or outside of the vehicle, which is required for the in-vehicle apparatus, without having to use a special content or a special browser.

In the in-vehicle display apparatus and the in-vehicle proxy server according to the present invention, a content is modified in accordance with information indicating the lightness inside and/or outside of the vehicle and information indicating a display color corresponding to the lightness inside/or outside of the vehicle, so that display information is displayed in a darker display color as the lightness inside and/or outside of the vehicle becomes darker. That is, it is possible to properly control displaying information such that display information is displayed in a darker display color as the lightness inside and/or outside of the vehicle becomes darker, which is required for the in-vehicle apparatus, without having to use a special content or a special browser.

In the in-vehicle display apparatus and the in-vehicle proxy server according to the present invention, information indicating the lightness inside and/or outside of the vehicle can be easily and surely acquired. This makes it possible to easily and properly control displaying information in terms of the display color of display information in a manner adapted to the in-vehicle apparatus.

In the in-vehicle display apparatus and the in-vehicle proxy server according to the present invention, a content is modified in accordance with information indicating the screen size of the display unit thereby allowing display information to be displayed in a layout adapted to the screen size of the display unit. That is, it is possible to properly control the display of information such that display information is displayed in the layout adapted to the screen size of the display unit so as to meet the requirement specific to the in-vehicle apparatus without having to use a special content or a special browser.

In the in-vehicle display apparatus and the in-vehicle proxy server according to the present invention, a content is modified in accordance with the vehicle running state information so that display information is displayed in a character size changed so as to be greater than a character size for use in the state in which the vehicle is at rest. That is, it is possible to properly control the display of information such that display information is displayed in a character size changed so as to be greater than the character size used in the state in which the vehicle is at rest, which a requirement specific to the in-vehicle apparatus, without having to use a special content or a special browser.

In the in-vehicle display apparatus and the in-vehicle proxy server according to the present invention, because it is possible to surely and easily acquire the information indicating the running state of the vehicle, it is possible to easily and surely control displaying information so as to meet the requirement specific to the in-vehicle apparatus such that display information is not displayed depending upon the vehicle running state.

In the in-vehicle display apparatus and the in-vehicle proxy server according to the present invention, a content is modified in accordance with the information indicating the information type acceptable by the in-vehicle display apparatus so that display information of an unacceptable type is not acquired. Thus, it is possible to control communication, taking into account the fact that mobile communication means is unreliable in connection and radio wave conditions are unstable, such that display information of an unacceptable type is not acquired. Note that information to be controlled is not limited to display information but any information which is unacceptable by the in-vehicle display apparatus can be controlled so as not to be acquired. This allows a reduction in communication cost when the communication fee is charged based on the measured rate. Furthermore, there is no restriction on HTML contents and the HTML browser, and thus high versatility in terms of the information type is achieved.

### BRIEF DESCRIPTION OF THE DRAWINGS

FIG. 1 is a block diagram showing an in-vehicle display apparatus and an in-vehicle proxy server for use therewith according to an embodiment of the present invention;

FIG. 2 shows examples of information supplied from a vehicle information providing system to an in-vehicle proxy server, an original content, and a content modified by the in-vehicle proxy server according to an embodiment of the present invention;

FIG. 3 is a flow chart showing a process associated with displaying information, performed by an in-vehicle display apparatus and an in-vehicle proxy server according to an embodiment of the present invention;

FIG. 4 shows examples of information supplied from a vehicle information providing system to an in-vehicle proxy server, an original content, and a content modified by the in-vehicle proxy server according to an embodiment of the present invention;

FIG. 5 shows a manner in which an image is displayed on a display screen of an in-vehicle display apparatus under the control of an in-vehicle proxy server according to an embodiment of the present invention;

FIG. 6 is a flow chart showing a process associated with the display of information, performed by an in-vehicle display apparatus and an in-vehicle proxy server according to an embodiment of the present invention;

FIG. 7 shows examples of information supplied from a vehicle information providing system to an in-vehicle proxy server, an original content, and a content modified by the in-vehicle proxy server according to an embodiment of the present invention;

FIG. 8 shows a manner in which an image is displayed on a display screen of an in-vehicle display apparatus under the control of an in-vehicle proxy server according to an embodiment of the present invention;

FIG. 9 is a flow chart showing a process associated with the display of information, performed by an in-vehicle display apparatus and an in-vehicle proxy server according to an embodiment of the present invention;

FIG. 10 shows examples of information supplied from a vehicle information providing system to an in-vehicle proxy server, an original content, and a content modified by the in-vehicle proxy server according to an embodiment of the present invention; and

FIG. 11 shows a data table in which settings are defined in terms of manners in which to control the display of information for a plurality of browsers according to an embodiment of the present invention.

### DESCRIPTION OF THE PREFERRED EMBODIMENTS

### First Embodiment

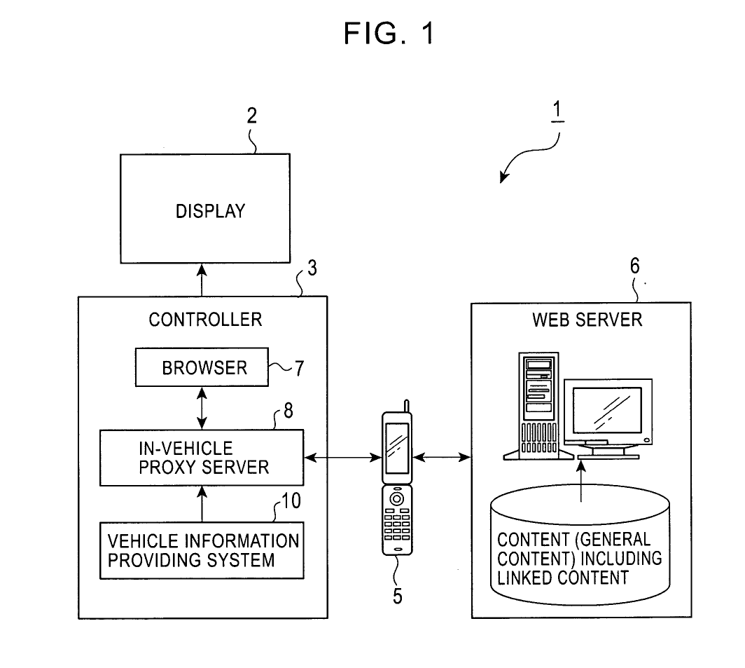

An in-vehicle display apparatus and an in-vehicle proxy server according to a first embodiment of the present invention are described below with reference to FIGS. 1 to 3.

In the present embodiment, it is assumed that the in-vehicle display apparatus is installed in an in-vehicle apparatus such as an in-vehicle navigation apparatus.

As shown in FIG. 1, the in-vehicle display apparatus 1 according to the present embodiment mainly includes a display 2 serving as a display unit, a controller 3 that controls the operation of displaying information on the display 2, and a portable telephone 5 serving as communication means connected to the controller 3.

The in-vehicle display apparatus 1 is capable of communicating with a Web server 6 serving as a server via the portable telephone 5.

The controller 3 has a browser 7 installed therein. As for the browser 7, a browser of general type (such as a browser component designed according to the HTML specifications established by W3C) designed without taking into account the possibility that the browser may be used by the in-vehicle apparatus.

In response to a command issued by a user, the browser 7 is capable of sending, to the Web server 6 via the portable telephone 5, a request for a content including a description specifying a linked content (a text file, a still image file, or a moving image file) which resides at a particular provider and which includes display information (information to be displayed such as text information or image information such as still image information or moving image information).

The provider of the specified linked content may be the Web server 6 that is the provider of the main content including the description specifying the linked content (hereinafter such a main content will also be referred to simply as a main content).

In the present embodiment, the main content may be a general HTML content (such as a content shown in FIG. 1) produced without taking into account the possibility that the content may be used by the in-vehicle apparatus.

The Web server 6 is configured such that in response to a request for main content issued by the in-vehicle display apparatus 1, the Web server 6 provides the requested main content to the in-vehicle display apparatus 1.

The main content provided by the Web server 6 is acquired by the controller 3 via the portable telephone 5.

In the conventional technique, the browser 7 directly acquires a main content and requests a provider to provide a linked content specified by a description included in the acquired main content. If the browser 7 acquires the linked content supplied from the provider in response to the request, the browser 7 displays information included in the acquired linked content on the display 2.

In contrast to the conventional technique, the in-vehicle display apparatus 1 according to the present embodiment is configured to properly control the display of information in a manner adapted to the in-vehicle apparatus.

More specifically, the controller 3 has an in-vehicle proxy server 8, and a particular local host (such as “Localhost/127.0.01”) is set in the in-vehicle proxy server 8.

If a request for a main content is issued by the browser 7, the main content supplied from the Web server 6 in response to the request is not directly supplied to the browser 7 but captured by the in-vehicle proxy server 8.

The controller 3 also has a vehicle information providing system 10 serving as information providing means.

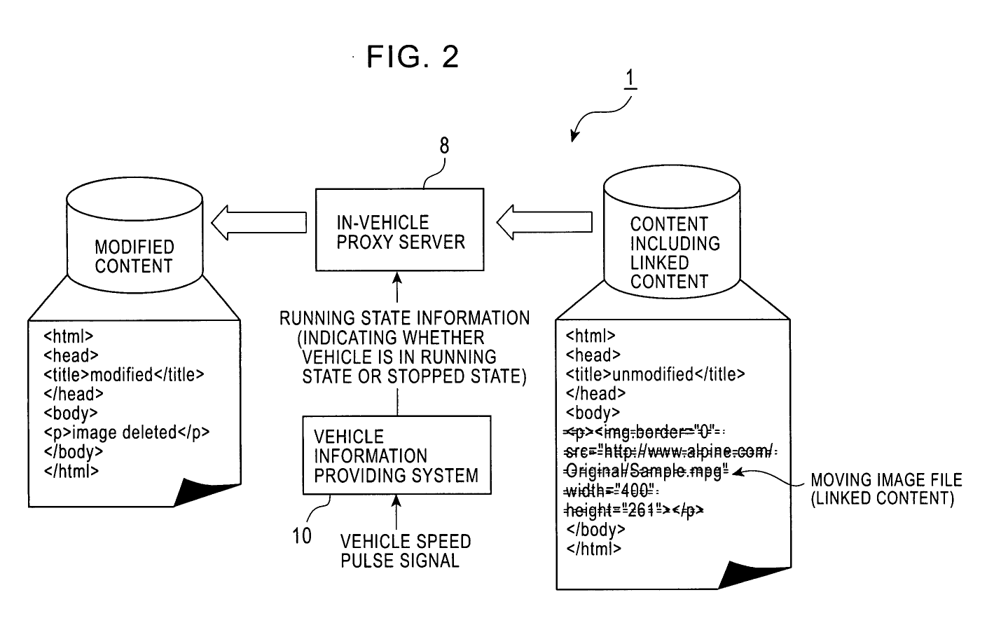

In the present embodiment, as shown in FIG. 2, the vehicle information providing system 10 is configured to generate information associated with the current running state of the vehicle (hereinafter referred to simply as running state information) and provide the generated running state information to the in-vehicle proxy server 8.

More specifically, the running state information is information which is sent to the in-vehicle proxy server 8 to notify whether the vehicle is currently running or is at rest.

As shown in FIG. 2, the vehicle information providing system 10 easily and correctly determines the current vehicle running state based on a vehicle speed pulse signal supplied from the vehicle, and generates running state information indicating the current vehicle running state.

Alternatively, the vehicle information providing system 10 may generate running state information based upon a parking brake signal or the like instead of the vehicle speed pulse signal.

Depending upon the running state information supplied from the vehicle information providing system 10, the in-vehicle proxy server 8 modifies the main content acquired from the Web server 6 such that information specifying the linked content including information which should not be displayed on the display 2 in the current vehicle running state is deleted from the main content.

More specifically, when the running state information acquired from the vehicle information providing system 10 indicates that the vehicle is currently running, the in-vehicle proxy server 8 modifies the main content such that a description indicating a moving image file (with an extension “mpg”) specified as a linked content is deleted from the main content as shown in FIG. 2.

That is, in the present embodiment, when the vehicle is currently running, it is determined that a moving image should not be displayed to secure safety, and a description specifying a moving image file including moving image data is deleted.

In the example shown in FIG. 2, the main content is described in the HTML language and includes a description of a src attribute, in a body part enclosed between <body> tags, specifying a moving image file (Sample.mpg in the example shown in FIG. 2) located at a particular provider (alpine.com in the example shown in FIG. 2).

The in-vehicle proxy server 8 deletes this description in the body. In FIG. 2, for easy understanding, the description (in the body) to be deleted is denoted by two broken lines.

In order to make it possible for the in-vehicle proxy server 8 to delete a description specifying a moving image file, it is required that the in-vehicle proxy server 8 should know that moving image information (moving image files) is specified as an information type which should not be displayed on the display 2 when the vehicle is running. To this end, for example, the vehicle information providing system 10 may provide to the in-vehicle proxy server 8, in addition to the running state information indicating that the vehicle is running, information indicating that the moving image is specified as the information type that is not allowed to be displayed when the vehicle is in this state indicated by the running state information. This makes it possible for the in-vehicle proxy server 8 to easily know that the moving image is specified as the information type that is currently not allowed to be displayed.

After the in-vehicle proxy server 8 deletes the description specifying the linked moving file from the main content and supplies the resultant content (hereinafter, such a resultant content will be referred to simply as a modified content) to the browser 7.

In accordance with the modified content supplied from the in-vehicle proxy server 8, the browser 7 does not request the provider to provide the moving image file including the linked moving information which is of the information type specified not to be displayed on the display 2. Thus, the modified content does not include the description specifying the moving image file as shown in FIG. 2, and the browser 7 does not request the moving image file.

Accordingly, no moving image file is provided to the in-vehicle display apparatus 1 from the provider, and thus it becomes possible to surely prevent any moving image from being displayed on the display 2.

A message may be displayed on the display 2 to notify that no moving image is displayed when the vehicle is running, or a message indicating that the moving image has been deleted.

Now, the operation of the present invention is described.

In the following explanation, for convenience, it is assumed that the Web server 6 is the provider of moving image files.

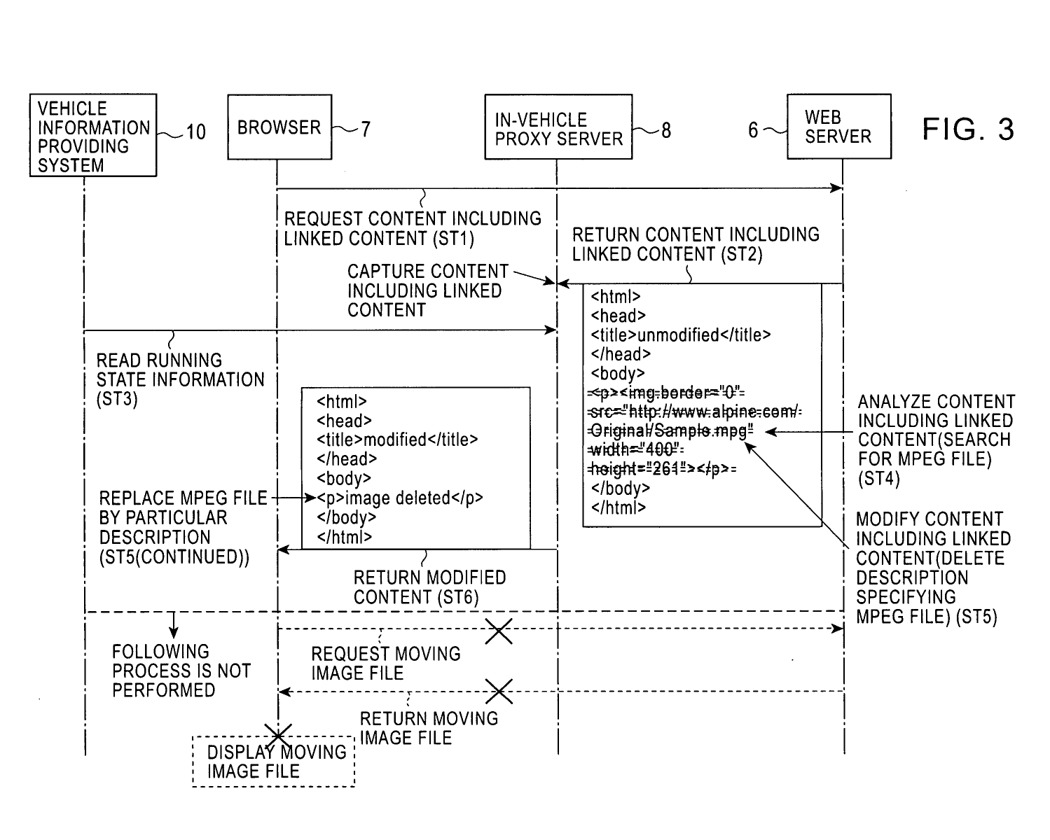

In the present embodiment, as shown in FIG. 3, the browser 7 requests the Web server 6 to provide the main content in step 1 (ST1).

In step 2 (ST2), in response to the request for the main content received in step 1 (ST1), the Web server 6 provides the main content to the in-vehicle display apparatus 1.

Note that in this process, the main content returned by the Web server 6 is not directly supplied to the browser 7 but is captured by the in-vehicle proxy server 8.

In step 3 (ST3), the in-vehicle proxy server 8 reads the running state information from the vehicle information providing system 10 thereby acquiring the running state information.

In the example shown in FIG. 3, the running state information information indicates that the vehicle is currently running.

In step 4 (ST4), the in-vehicle proxy server 8 analyzes the main content acquired from the Web server 6 to determine whether the main content includes a portion to be modified depending upon the current vehicle running state in accordance with the running state information (indicating that the vehicle is currently in the running state, in this specific example) acquired in step 3 (ST3).

In the example shown in FIG. 3, because the vehicle is currently running, the in-vehicle proxy server 8 performs text retrieval over the main content to find a portion to be modified, that is, a description specifying an MPEG file (linked content) or a moving image file.

In step 5 (ST5), if a portion is found which should be modified, then the in-vehicle proxy server 8 performs necessary modification on the found portion in the main content.

In the example shown in FIG. 3, a description specifying an MPEG file, that is, a body part enclosed between body tags (<body>) is deleted. Note that in FIG. 3, for easy understanding, two broken lines are superimposed on the body part enclosed between body tags in the main content to indicate that this part has been deleted.

At the location where the deleted part was present before the deletion, text information and HTML tags are described so that a message “Image Deleted” will be displayed on the display 2.

In step 6 (ST6), the in-vehicle proxy server 8 supplies the resultant modified content, which has been obtained via the modification made on the main content in step 5 (ST5), to the browser 7.

If the browser 7 receives the modified content from the in-vehicle proxy server 8, the browser 7 executes the script described in the modified content.

In this specific case, because the modified content includes no description specifying a moving image file, the browser 7 does not issue a request for a moving image file to the Web server 6 (that is, in FIG. 3, a corresponding step denoted by symbols x is not executed).

Because the Web server 6 does not receive the request from the browser 7, the Web server 6 does not supply the moving image file to the browser 7 (that is, in FIG. 3, a corresponding step denoted by symbols x is not executed).

Because the browser 7 does not request the Web server 6 to provide the moving image file, and thus browser 7 does not download the moving image file from the Web server 6 and does not display the moving image file on the display 2 (that is, in FIG. 3, a corresponding step denoted by symbols x is not executed).

The browser 7 displays only the message “Image Deleted” on the display 2 without displaying the moving image file.

Thus, in the present embodiment, the in-vehicle proxy server 8 modifies the main content (such that the description specifying the moving image file is deleted) in accordance with the running state information supplied from the vehicle information providing system 10 thereby preventing the browser 7 from requesting the linked content (the moving image file) including display information (moving image information) that should not be displayed on the display 2 when the vehicle is in the current running state (in the specific example described above, the vehicle is currently running).

This ensures that the display of information is controlled such that information of the type which should not be displayed is prevented from being displayed depending on the vehicle running state.

More specifically, the display of information is properly controlled so as to meet the requirements specific to the in-vehicle apparatus such that information of a particular type, such as moving image information, specified not to be displayed in a particular vehicle running state is surely prevented from being displayed thereby securing safety in driving the vehicle. Because the modification of a main content including a description specifying a linked content is made by the in-vehicle proxy server 8, there is no particular restriction on the type of main contents (for example, HTML contents designed to be displayed on a personal computer may be used), and thus high versatility in terms of the information type is achieved. Furthermore, because information (moving image information) which is not displayed is not acquired, it is possible to prevent cost from being spent for useless communication. Furthermore, a common browser (such as that designed according to the HTML specifications established by W3C) can be used without having to make a particular design modification to adapt to the in-vehicle apparatus. This allows further high versatility to be achieved.

The present embodiment may be modified such that control of displaying of information is performed when the running state information provided to the in-vehicle proxy server 8 from the vehicle information providing system 10 indicates that the vehicle is currently running at a speed higher than a predetermined speed.

In this case, the in-vehicle proxy server 8 modifies a main content including a description specifying a linked content (such that the description specifying a moving image file is deleted) when the running state information provided from the vehicle information providing system 10 indicates that the vehicle is currently running at a speed higher than the predetermined speed, thereby preventing the browser 7 from requesting the Web server 6 to supply the moving image file. This ensures that no moving image is displayed on the display 2 when the vehicle is running at a speed higher than the predetermined speed.

Still image information such as a JPEG or GIF file may be specified as an information type which should be controlled in terms of displaying in accordance with the present embodiment.

In this case, the in-vehicle proxy server 8 modifies a main content (such that a description specifying a still image file is deleted) in accordance with the running state information, thereby preventing the browser 7 from requesting the still image when the vehicle is in the running state or when the vehicle is running at a speed higher than the predetermined speed. This ensures that no still image is displayed on the display 2 when the vehicle is running when the vehicle is running at a speed higher than the predetermined speed.

The present embodiment may be applied to both a browser 7 installed in a driver's seat area as to control displaying of information on the display 2 installed in the driver's seat area and one or more browsers 7 installed in a rear seat area so as to control the display of information on displays 2 installed in the rear seat area.

In this case, the in-vehicle proxy server 8 may directly transfer an unmodified main content including a description specifying a linked content including a moving image file or a still image file to the browser 7 installed in the rear seat area without deleting the description specifying the linked content even when the vehicle is running or when the vehicle is running at a speed higher than the predetermined speed.

This allows the browser 7 installed in the rear seat area to request the moving image file or the still image file in accordance with the unmodified main content transferred from the in-vehicle proxy server 8 and display the acquired moving image or the still image on the display 2 installed in the rear seat area even when the vehicle is running or when the vehicle is running at a speed higher than the predetermined speed.

Thus, it is possible to realize a rear entertainment system in which the display 2 installed in the rear seat area is allowed to display any information including a moving image or a still image regardless of whether the vehicle is running or regardless of the running speed without concern for safety.

### Second Embodiment

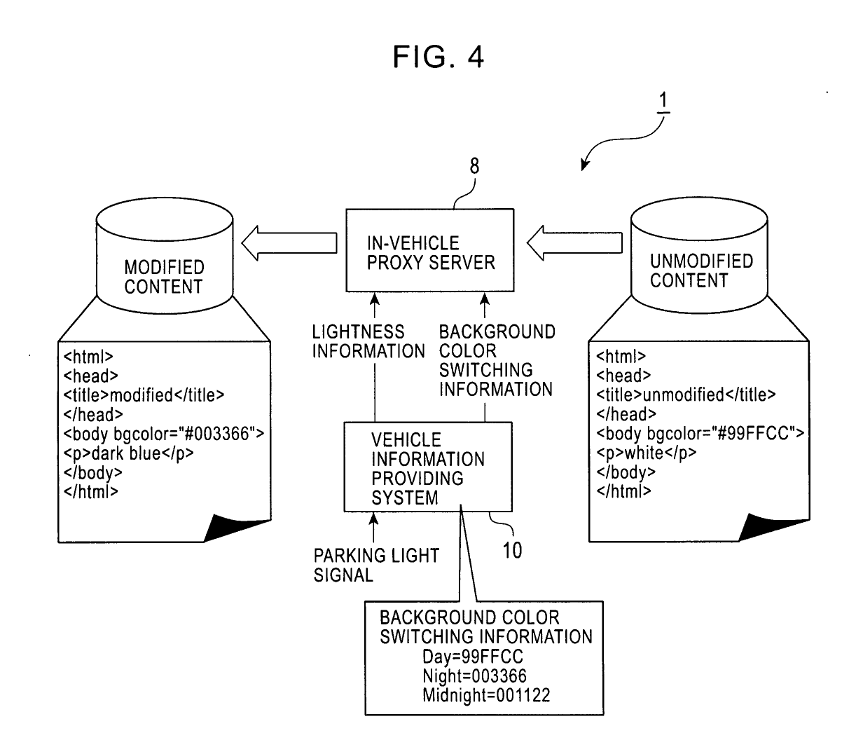

An in-vehicle display apparatus and an in-vehicle proxy server according to a second embodiment of the present invention are described below with reference to FIGS. 4 to 6.

The in-vehicle display apparatus according to the second embodiment is similar in physical configuration to that according to the first embodiment described above with reference to FIG. 1 and similar parts are denoted by similar reference numerals.

In the present embodiment, a browser 7 of the in-vehicle display apparatus 1 is adapted to, in response to a command issued by a user, request via a portable telephone 5 a Web server 6 to provide an HTML content in which display information including information specifying display colors such as a background color (<body bgcolor>) is described as shown in FIG. 4 (hereinafter, such an HTML content will be referred to simply as an unmodified content).

In response to the request for the unmodified content issued by the in-vehicle display apparatus 1, the Web server 6 provides the unmodified content to the in-vehicle display apparatus 1.

The unmodified content provided by the Web server 6 is acquired by the controller 3 via the portable telephone 5.

In the conventional technique, the browser 7 directly directly acquires the unmodified content and displays the information included in the acquired content on the display 2 such that the information is displayed in the same background color as that specified in the acquired unmodified content.

In contrast to the conventional technique, the in-vehicle display apparatus 1 according to the present embodiment is configured to control the background color so that the background color meets the requirements specific to the in-vehicle apparatus.

More specifically, as shown in FIG. 4, when the content is provided by the Web server 6 in response to the request for the unmodified content issued by the browser 7, the content is not supplied directly to the browser 7 but is captured by the in-vehicle proxy server 8.

Furthermore, as shown in FIG. 4, the vehicle information providing system 10 according to the present embodiment is configured to generate information indicating current lightness inside/outside of the vehicle (hereinafter referred to simply as lightness information) and provide the generated lightness information to the in-vehicle proxy server 8.

Furthermore, as shown in FIG. 4, the vehicle information information providing system 10 is configured to easily and accurately determine the current lightness inside/outside of the vehicle based on a parking light signal supplied from the vehicle and generate the light information indicating the determined current lightness inside/outside of the vehicle.

Furthermore, as shown in FIG. 4, the vehicle information providing system 10 is configured to provide, to the in-vehicle proxy server 8, background color switching information specifying a background color to be used depending on the lightness indicated by the lightness information.

In the example shown in FIG. 4, the background color switching information specifies three colors (with color codes) to be used depending on the lightness, that is, a color (Day=99FFCC) to be used in the daytime, a color (Night=003366) to be used in the nighttime, and a color (Midnight=001122) to be used in the midnight.

The background color switching information provided by the vehicle information providing system 10 to the in-vehicle proxy server 8 may include only information specifying a particular color to be used in the current lightness indicated by the lightness information.

In this case, for example, when the lightness information provided to the in-vehicle proxy server 8 indicates that the current lightness is daytime lightness, the background color switching information includes only information specifying the background color to be used in the daytime. On the other hand, when the lightness information indicates that the current lightness is nighttime lightness, the provided background color switching information includes only information specifying the background color to be used in the nighttime.

Alternatively, the background color switching information provided by the vehicle information providing system 10 to the in-vehicle proxy server 8 may indicate all background colors to be selectively used depending upon the lightness. In this case, the in-vehicle proxy server 8 determines the background color to be used in the current lightness indicated by the provided lightness information in accordance with the background color switching information provided by the vehicle information providing system 10.

In accordance with the lightness information and the background color switching information supplied from the vehicle information providing system 10, the in-vehicle proxy server 8 modifies the unmodified content acquired from the Web server 6 such that the content will be displayed in the background color specified by the lightness information.

For example, when the lightness information supplied from the vehicle information providing system 10 indicates that the current lightness is nighttime lightness, the in-vehicle proxy server 8 changes a description (“#99FFCC”) enclosed in background color tags (<body bgcolor>) in the display information into the background color information (“#003366”) for use in the nighttime supplied from the vehicle information providing system 10, as shown in FIG. 4.

The in-vehicle proxy server 8 provides the content modified in terms of the background color (hereinafter referred to simply as the modified content) to the browser 7.

In accordance with the modified content provided by the in-vehicle proxy server 8, the browser 7 reproduces the display information with the modified background color and displays it on the display 2.

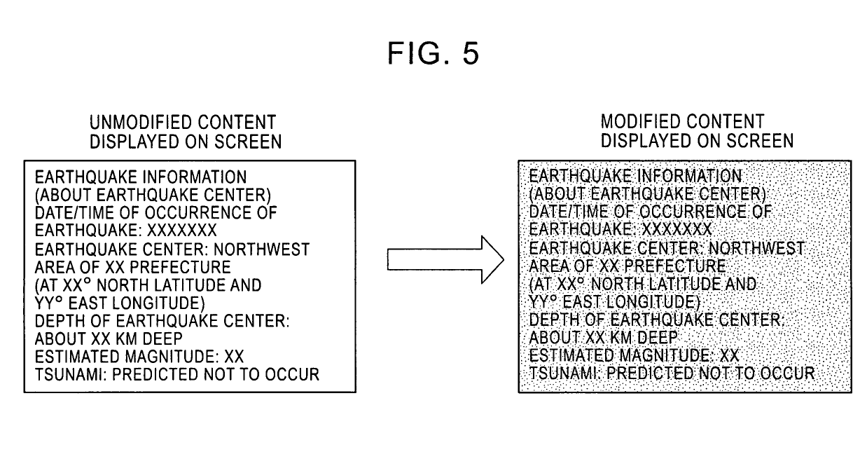

This makes it possible to display information with a background color adaptively selected depending upon the current lightness. For example, as shown in FIG. 5, even when an unmodified content has a bright background color, if the current lightness is nighttime lightness, then the content is modified such that it has a dark background color for use in the nighttime and the resultant modified content is displayed on the display 2.

Now, the operation of the present embodiment is described below.

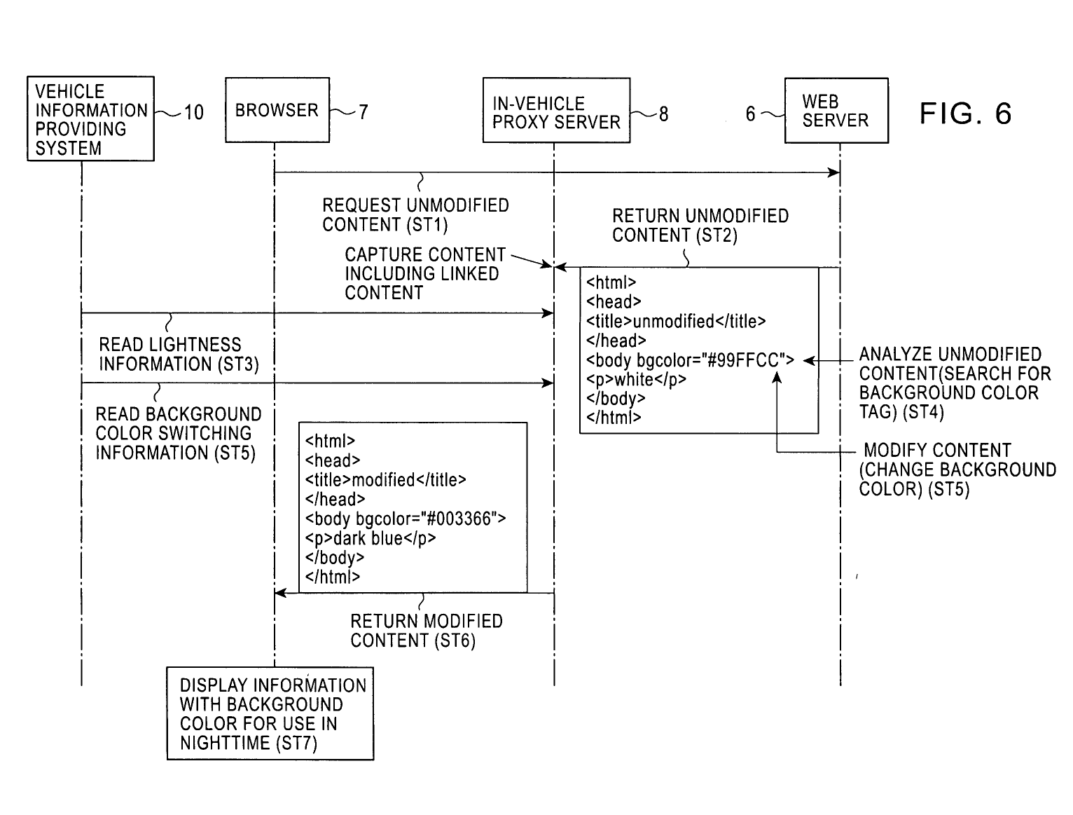

In the present embodiment, as shown in FIG. 6, the browser 7 requests the Web server 6 to provide the unmodified content in step 1 (ST1).

In step 2 (ST2), in response to the request for the unmodified content received in step 1 (ST1), the Web server 6 provides the unmodified content to the in-vehicle display apparatus 1.

Note that in this process, the unmodified content returned by the Web server 6 is not directly supplied to the browser 7 but is captured by the in-vehicle proxy server 8.

In step 3 (ST3), the in-vehicle proxy server 8 reads the lightness information from the vehicle information providing system 10 thereby acquiring the lightness information. The in-vehicle proxy server 8 analyzes the acquired lightness information to detect the lightness inside/outside of the vehicle.

In the example shown in FIG. 6, the lightness information indicates that the current lightness is nighttime lightness.

In step 4 (ST4), the in-vehicle proxy server 8 analyzes the unmodified content acquired from the Web server 6. More specifically, a text retrieval is performed to retrieve a tag (<body bgcolor>) indicating a background color from the display information described in the unmodified content.

In step 5 (ST5), the in-vehicle proxy server 8 reads the background color switching information from the vehicle information providing system 10.

Thereafter, the in-vehicle proxy server 8 modifies the unmodified content such that information described in a part enclosed between background color tags from the code (“#99FFCC”) indicating the background color for use in the daytime to the code (“#003366”) indicating the background color for use in the nighttime according to the lightness information acquired in step 3 (ST3).

In step 6 (ST6), the in-vehicle proxy server 8 transfers the resultant modified content, which has been obtained via the modification made on the unmodified content in step 5 (ST5), to the browser 7.

In step 7 (ST7), in accordance with the modified content supplied from the in-vehicle proxy server 8, the browser 7 displays the information with the background color changed into the color for use in the nighttime on the display 2.

Thus, in the present embodiment, the in-vehicle proxy server 8 modifies the unmodified content (such that the background color is changed) in accordance with the lightness information supplied from the vehicle information providing system 10, so that the information with the background color adaptively changed depending on the lightness (indicated by the lightness information) inside/outside of the vehicle. More specifically, the employed background color becomes darker as the lightness inside/outside of the vehicle becomes darker.

Thus, it is possible to properly control displaying of information in a manner adapted to the in-vehicle apparatus such that the background color of the display information is changed to a color adapted to the lightness inside/outside of the vehicle, without having to use a special HTML content or a special HTML browser.

Note that the present embodiment may be applied to both the browser 7 located in the driver's seat area to display information on the display 2 located in the driver's seat area and the browser 7 located in the rear seat area to display information on the display 2 located in the rear seat area.

### Third Embodiment

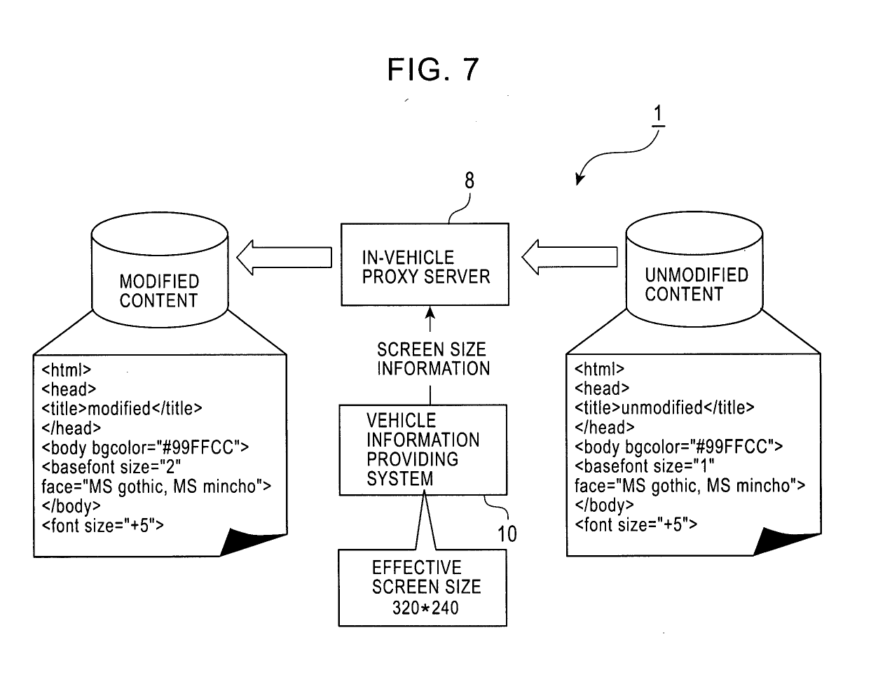

An in-vehicle display apparatus and an in-vehicle proxy server according to a third embodiment of the present invention are described below with reference to FIGS. 7 to 9.

The in-vehicle display apparatus according to the third embodiment is similar in physical configuration to that according to the first embodiment described above with reference to FIG. 1 and similar parts are denoted by similar reference numerals.

In the present embodiment, a browser 7 of the in-vehicle display apparatus 1 is adapted to, in response to a command issued by a user, request via a portable telephone 5 a Web server 6 to provide an HTML content in which display information including layout information specifying a font size (<basefont size>) is described as shown in FIG. 7 (hereinafter, such an HTML content will be referred to simply as an unmodified content).

In response to a request for an unmodified content issued by the in-vehicle display apparatus 1, the Web server 6 provides the unmodified content to the in-vehicle display apparatus 1.

The unmodified content provided by the Web server 6 is acquired by the controller 3 via the portable telephone 5.

In the conventional technique, the browser 7 directly acquires the unmodified content and displays the information included in the acquired content on the display 2 such that the displayed information has the same font size as that specified in the acquired unmodified content.

In contrast to the conventional technique, the in-vehicle display apparatus 1 according to the present embodiment is configured to control the layout in terms of the font size so that the font size meets the requirements specific to the in-vehicle apparatus.

More specifically, as shown in FIG. 7, when the content is provided by the Web server 6 in response to the request for the unmodified content issued by the browser 7, the content is not supplied directly to the browser 7 but is captured by the in-vehicle proxy server 8.

Furthermore, as shown in FIG. 7, the vehicle information providing system 10 according to the present embodiment generates information associated with the screen size of the display 2 (hereinafter referred to simply as the screen size information) and supplies the generated screen size information to the in-vehicle proxy server 8.

In the example shown in FIG. 7, the screen size information indicates that the effective screen size of the display 2 is 320 dots (in the horizontal direction)×240 dots (in the vertical direction).

According to the screen size information supplied from the vehicle information providing system 10, the in-vehicle proxy server 8 modifies the unmodified content acquired from the Web server 6 such that the font size of the information to be displayed is changed to a font size to adapt to the screen size indicated by the screen size information.

More specifically, as shown in FIG. 7, the in-vehicle proxy server 8 changes information described between basefont tags (<basefont size> to indicate the size property in terms of the font size of the information to be displayed from the current value (size=“1”) to a value (size=“2”) to adapt to the screen size indicated by the screen size information supplied from the vehicle information providing system 10.

The in-vehicle proxy server 8 provides the content modified in terms of the font size (hereinafter referred to simply as the modified content) to the browser 7.

In accordance with the modified content provided by the in-vehicle proxy server 8, the browser 7 displays the information in the modified font size on the display 2.

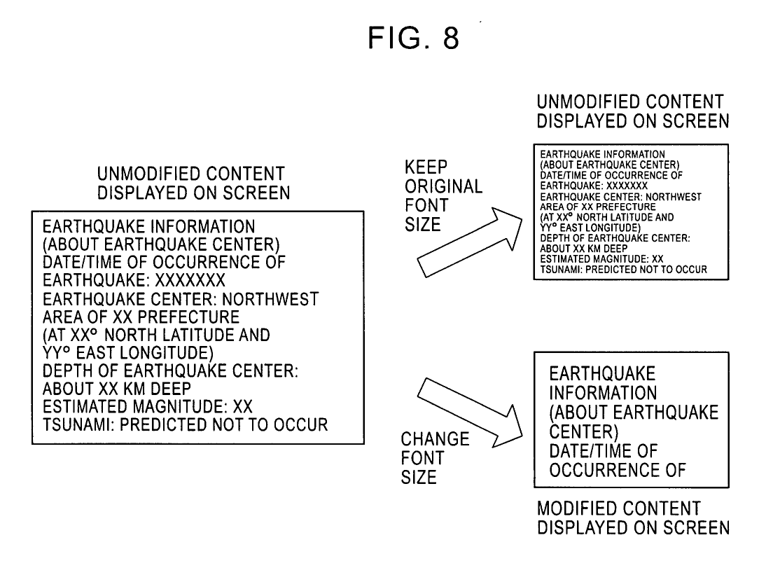

As a result, as shown in FIG. 8, the modified content is displayed in the greater character size as compared to the case in which the unmodified content with the original font size is directly displayed.

Now, the operation of the present embodiment is described below.

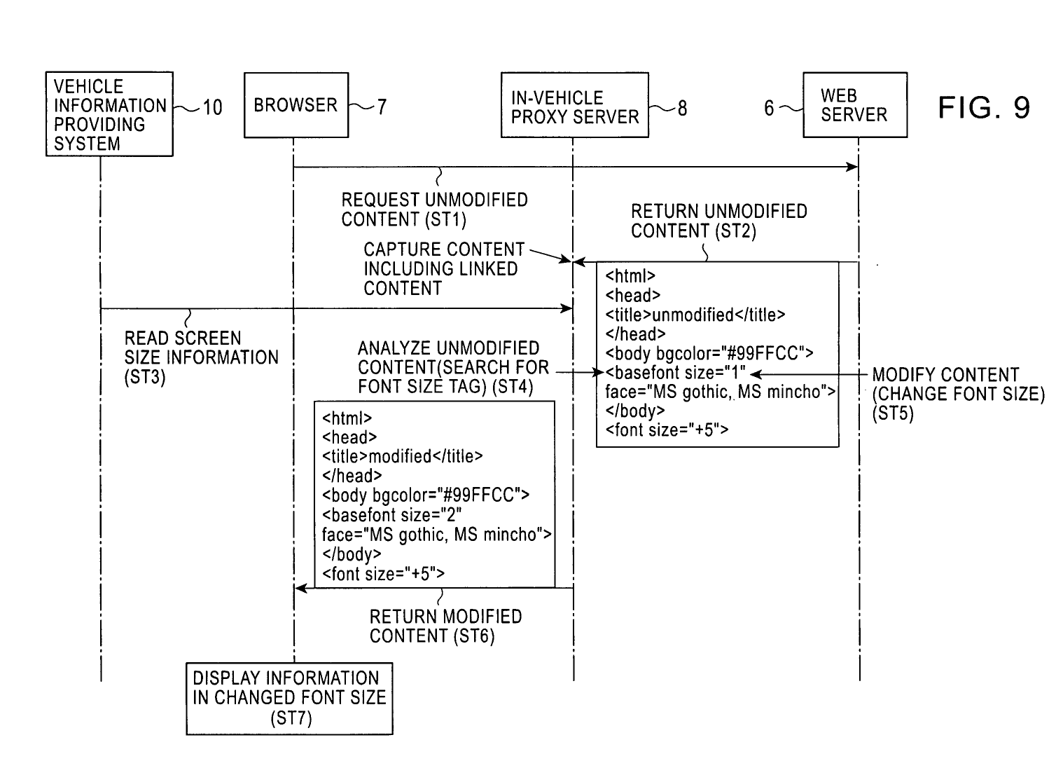

In the present embodiment, as shown in FIG. 9, the browser 7 requests the Web server 6 to provide the unmodified content in step 1 (ST1).

In step 2 (ST2), in response to the request for the unmodified content received in step 1 (ST1), the Web server 6 provides the unmodified content to the in-vehicle display apparatus 1.

Note that in this process, the unmodified content returned by the Web server 6 is not directly supplied to the browser 7 but is captured by the in-vehicle proxy server 8.

In step 3 (ST3), the in-vehicle proxy server 8 reads the screen size information from the vehicle information providing system 10 thereby acquiring the screen size information. Based on the acquired screen size information, the in-vehicle proxy server 8 analyzes the screen size of the vehicle.

In step 4 (ST4), the in-vehicle proxy server 8 then analyzes the unmodified content acquired from the Web server 6. More specifically, the in-vehicle proxy server 8 performs a text retrieval to retrieve a font size tag (<basefont size>) from the information described in the unmodified content.

In step 5 (ST5), the in-vehicle proxy server 8 modifies the unmodified content such that information described between font size tags (<basefont size> in the unmodified content is changed from the current value (size=“1”) to a value (size=“2”) to adapt to the screen size indicated by the screen size information acquired in step 3 (ST3).

In step 6 (ST6), the in-vehicle proxy server 8 transfers the resultant modified content, which has been obtained via the modification made on the unmodified content in step 5 (ST5), to the browser 7.

In step 7 (ST7), in accordance with the modified content provided by the in-vehicle proxy server 8, the browser 7 displays the information in the modified font size on the display 2.

Thus, in the present embodiment, the in-vehicle proxy server 8 modifies the unmodified content (such that the font size is changed) in accordance with the screen size information supplied from the vehicle information providing system 10, thereby allowing the information to be displayed in the font size adapted to the screen size (indicated by the screen size information) of the display 2.

Thus, it is possible to control the display of information in the manner adapted to the in-vehicle apparatus such that the font size of the display information is controlled so as to adapt to the screen size of the display 2, without having to use a special HTML content or a special HTML browser.

Note that the present embodiment may be applied to both the browser 7 located in the driver's seat area to display information on the display 2 located in the driver's seat area and the browser 7 located in the rear seat area to display information on the display 2 located in the rear seat area.

### Fourth Embodiment

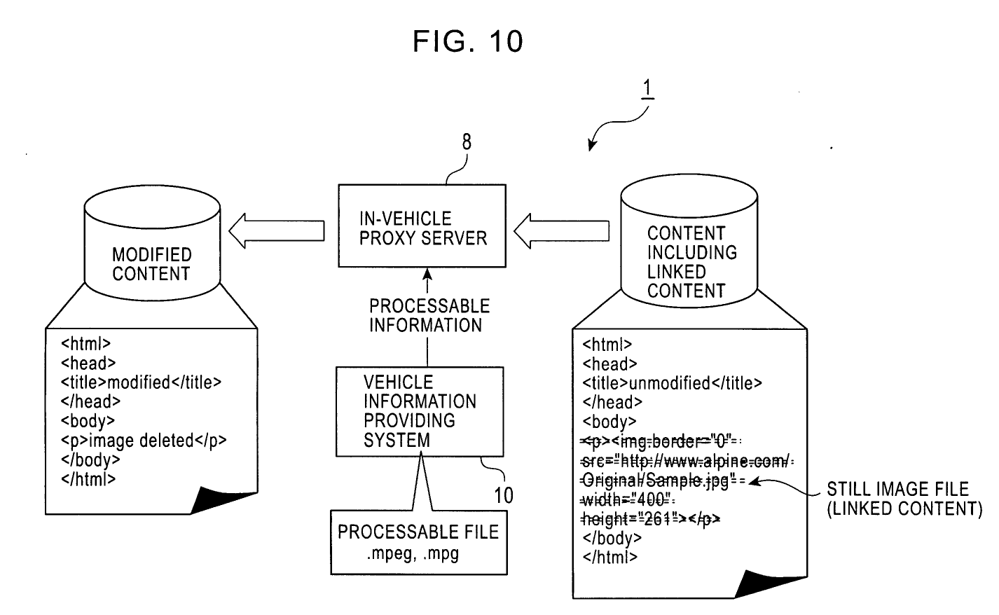

An in-vehicle display apparatus and an in-vehicle proxy server according to a fourth embodiment of the present invention are described below with reference to FIG. 10.

The in-vehicle display apparatus according to the fourth embodiment is similar in physical configuration to that according to the first embodiment described above with reference to FIG. 1 and similar parts are denoted by similar reference numerals.

As in the first embodiment, in response to a command issued by a user, the browser 7 transmits, to a Web server 6 via a portable telephone 5, a request for a content including a description specifying a linked content (a text file, a still image file, or a moving image file) which resides at a particular provider and which includes display information (information to be displayed such as text information or image information such as still image information or moving image information).

The provider of the specified linked content may be the Web server 6 that is the provider of the main content including the description specifying the linked content (hereinafter such a main content will be referred to simply as a main content).

In response to the request for the main content issued by the in-vehicle display apparatus 1, the Web server 6 the Web server 6 provides the requested main content to the in-vehicle display apparatus 1.

The main content provided by the Web server 6 is acquired by the controller 3 via the portable telephone 5.

The in-vehicle display apparatus 1 according to the present embodiment is configured to properly control the display of information in a manner adapted to the in-vehicle apparatus.

In the present embodiment, as shown in FIG. 10, when the main content is provided by the Web server 6 in response to the content request issued by the browser 7, the provided main content is not directly supplied to the browser 7 but is captured by the in-vehicle proxy server 8.

Furthermore, as shown in FIG. 10, the vehicle information providing system 10 according to the present embodiment provides, to the in-vehicle proxy server 8, information indicating types of information which is acceptable (can be handled) by the in-vehicle display apparatus 1 (hereinafter, such information will be referred to as acceptable data type information.

In the example shown in FIG. 10, the acceptable data type information indicates that data files with a file extension “.mpeg” or “.mpg” are acceptable by the in-vehicle display apparatus 1.

In accordance with the acceptable data type information supplied from the vehicle information providing system 10, the in-vehicle proxy server 8 modifies the main content acquired from the Web server 6 such that descriptions specifying linked contents of types other than those acceptable by the in-vehicle display apparatus 1 are deleted.

More specifically, when the acceptable data type information acquired from the vehicle information providing system 10 indicates that moving image files with a file extension “.mpeg” or “.mpg” are acceptable, the in-vehicle proxy server 8 modifies the main content such that descriptions specifying files such as a still image file (with an extension “.jpg”) other than acceptable moving files are deleted, as shown in FIG. 10.

In the example shown in FIG. 10, a part denoted by two broken lines is the deleted description specifying unacceptable file types.

The in-vehicle proxy server 8 deletes the description specifying the still image file from the main content and transfers the resultant content (hereinafter, such a resultant content will be referred to simply as a modified content) to the browser 7.

In accordance with the modified content supplied from the in-vehicle proxy server 8, the browser 7 does not request the provider to provide the specified linked content, that is, the still image file that is of the data type unacceptable by the in-vehicle display apparatus 1. Thus, the modified content does not include the description specifying the still Image file, as shown in FIG. 10, and the browser 7 does not request the still image file.

Accordingly, no still image file is provided to the in-vehicle display apparatus 1 from the provider. This surely prevents the still image file unacceptable by the in-vehicle display apparatus 1 from being acquired.

In this situation, a text message “Image has been deleted” may be displayed on the display 2.

Thus, in the present embodiment, the in-vehicle proxy server 8 modifies the unmodified content (such that the description specifying the file other than files of the types acceptable by the vehicle information providing system 1 is deleted) in accordance with the acceptable data type information supplied from the vehicle information providing system 10. This surely prevents files of types unacceptable by the in-vehicle display apparatus 1 from being acquired.

Thus, it is possible to control communication, taking into account the fact that mobile communication means is unreliable in connection and radio wave conditions are unstable, such that display information of an unacceptable type is not acquired. This also allows a reduction in communication cost when the communication fee is charged based upon the measured rate. Furthermore, there is no restriction on HTML contents and a HTML browser, and thus high versatility can be achieved.

In the present embodiment described above, it is assumed that the file type acceptable by the in-vehicle display apparatus 1 is the moving image file. However, files other than the moving image file may be acceptable by the in-vehicle display apparatus 1.

The present embodiment may be applied to both the browser 7 located in the driver's seat area to display information on the display 2 located in the driver's seat area and the browser 7 located in the rear seat area to display information on the display 2 located in the rear seat area.

Although the present invention has been described above with reference to specific embodiments, the invention is not limited to details of these embodiments, but various modifications are possible.

For example, when the vehicle running state information supplied to the in-vehicle proxy server 8 from the vehicle information providing system 10 indicates that the vehicle is currently running, the in-vehicle proxy server 8 may modify a content including display information acquired from the Web server 6 such that the character size of the display information is increased so as to be greater than the character size for use in the state in which the vehicle is at rest, and the resultant modified content may be supplied to the browser 7.

This makes it possible for the browser 7 to display on the display 2 the display information in the character size changed so as to be greater than the character size for use in the state in which the vehicle is at rest, in accordance with the modified content supplied from the in-vehicle proxy server 8. That is, it is possible to properly control the display of information such that display information is displayed in a character size changed so as to be greater than the character size used in the state in which the vehicle is at rest, which may be a requirement specific to the in-vehicle apparatus, without having to use a special content or a special browser.

The in-vehicle proxy server 8 may operate in the processes described in the respective embodiments in a parallel manner.

As described above, the techniques disclosed respectively in the first to fourth embodiments may be applied to both the browser 7 located in the driver's seat area and the browser 7 located in the rear seat area. More specifically, the in-vehicle proxy server 8 may be configured to control the display of information depending upon the vehicle running state, the lightness, and/or the screen size individually for each of a plurality of browsers 7.

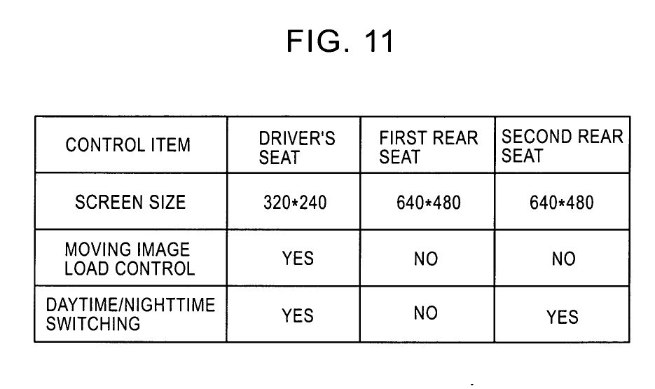

To this end, for example, the in-vehicle proxy server 8 may have a data table such as that shown in FIG. 11. In the example of the data table shown in FIG. 11, settings in terms of the screen size, the control of loading moving images, and the daytime/nighttime switching are defined for respective browsers 7 located in the driver's seat area, the first rear seat area, and the second rear seat area.

If a content acquisition request is issued by a particular browser 7, the in-vehicle proxy server 8 modifies the content acquired from the Web server 6 in accordance with the settings defined for this particular browser 7.

In the example shown in FIG. 11, the settings are made such that the control of displaying moving images in the state in which the vehicle is running is not performed for the two browsers 7 located respectively in the first rear seat area and the second rear seat area. In accordance with the settings, the in-vehicle proxy server 8 supplies a main content to these to browsers 7 in the rear seat areas without deleting a description specifying a moving image file from the content. Thus, the two browsers 7 located in the rear seat areas are allowed to request a moving image file and display it on the displays 2 located in the respective rear seat areas even in the state in which the vehicle is running.

On the other hand, as for the control of the daytime/nighttime switching, the in-vehicle proxy server 8 performs control in accordance with the data table shown in FIG. 11 such that the background color of the content is modified in accordance with the parking light signal only for the content acquired in response to a request issued by the browser 7 located in the driver's seat area or the browser 7 located in the second rear seat area.

In the example of the data table shown in FIG. 11, the in-vehicle proxy server 8 modifies contents depending upon the screen size such that the font size of a content acquired in response to a request from the browser 7 located in the first rear seat area or the browser 7 located in the second rear seat area is greater than the font size of a content acquired in response to a request from the browser 7 located in the driver's seat area.

Note that the data table set in the in-vehicle proxy server 8 is not limited to that shown in FIG. 11, but the settings may be made differently.

While there has been illustrated and described what is at present contemplated to be preferred embodiments of the present invention, it will be understood by those skilled in the art that various changes and modifications may be made, and equivalents may be substituted for elements thereof without departing from the true scope of the invention. In addition, many modifications may be made to adapt a particular situation to the teachings of the invention without departing from the central scope thereof. Therefore, it is intended that this invention not be limited to the particular embodiments disclosed, but that the invention will include all embodiments falling within the scope of the appended claims.

What is claimed is:

1. An in-vehicle display apparatus configured such that a browser requests that a server provide a content that includes a description specifying a linked content including display information residing on a provider, requests that the provider provide a linked content in accordance with the content supplied from the server, and displays display information included in the linked content, the in-vehicle display apparatus comprising:
an in-vehicle proxy server operable to acquire the content supplied from the server in response to the content request issued by the browser; and
an information providing unit operable to provide information to the in-vehicle proxy server indicating a running state of a vehicle,
wherein the in-vehicle proxy server is operable to (1) modify the content acquired in accordance with the information indicating the running state such that any description specifying a linked content that includes display information not to be displayed in the current vehicle running state is deleted from the content and (2) supply the resultant modified content to the browser; and
the browser does not request the linked content that includes the display information not to be displayed in accordance with the modified content.

2. The in-vehicle display apparatus according to claim 1, wherein:
when the information indicating the running state indicates that the vehicle is currently running, the in-vehicle proxy server (1) modifies the content acquired from the server such that any description specifying a linked content that includes image information as the display information not to be displayed is deleted from the content, and (2) supplies the resultant modified content to the browser; and
the browser does not request the linked content that includes the image information.

3. The in-vehicle display apparatus according to claim 2, wherein the image information is moving image information.

4. The in-vehicle display apparatus according to claim 2, wherein:
the in-vehicle proxy server operates with both a first browser operable to display information on a first display located in the driver's seat area and a second browser operable to display information on a second display located in the rear seat area; and
the in-vehicle proxy server is operable to supply the content maintaining the description specifying the linked content that includes the image information to the second browser even when the vehicle is currently running such that the image information is displayed on the second display even when the vehicle is currently running.

5. The in-vehicle display apparatus according to claim 1, wherein:
when the information indicating the running state indicates that the vehicle is currently running at a speed higher than a predetermined speed, the in-vehicle proxy server (1) modifies the content acquired from the server such that the description specifying the linked content that includes image information as the display information not to be displayed is deleted from the content, and (2) supplies the resultant modified content to the browser; and
in accordance with the modified content, the browser does not request the linked content that includes the image information.

6. The in-vehicle display apparatus according to claim 5, wherein:
the in-vehicle proxy server operates with both a first browser operable to display information on a first display located in the driver's seat area and a second browser operable to display information on a second display located in the rear seat area, and the in-vehicle proxy server is allowed to supply the content maintaining the description specifying the linked content that includes the image information to the second browser even when the vehicle is currently running at the speed higher than the predetermined speed; and
in accordance with the content supplied from the in-vehicle proxy server, the second browser is allowed to request the linked content that includes the image information and display the image information on the second display even when the vehicle is currently running at the speed higher than the predetermined speed.

7. An in-vehicle display apparatus configured such that a browser requests that a server provide a content that includes display information and displays the display information included in the content provided from the server in response to the content request, the in-vehicle display apparatus comprising:
an in-vehicle proxy server operable to acquire the content provided from the server in response to the content request issued by the browser; and
an information providing unit operable to supply information indicating (1) the lightness inside and/or outside of a vehicle and (2) a first display color corresponding to the lightness inside and/or the outside of the vehicle,
wherein the in-vehicle proxy server is operable to (1) modify the content acquired from the server such that a second display color of the display information is changed to the first display color in accordance with the information indicating the lightness inside and/or outside of the vehicle, and (2) supply the resultant modified content to the browser; and
the browser is operable to display the display information with the changed second display color on a display unit in accordance with the modified content.

8. The in-vehicle display apparatus according to claim 7, wherein the first display color corresponding to the lightness inside and/or outside of the vehicle becomes darker as the lightness inside and/or outside of the vehicle becomes darker.

9. The in-vehicle display apparatus according to claim 7, wherein the information indicating the lightness inside and/or outside of the vehicle is information generated based upon a parking light signal.

10. An in-vehicle display apparatus configured such that a browser requests that a server provide a content that includes display information and displays the display information included in the content provided from the server in response to the content request, the in-vehicle display apparatus comprising:
an in-vehicle proxy server operable to acquire the content provided from the server in response to the content request issued by the browser; and
an information providing unit operable to provide information to the in-vehicle proxy server indicating the screen size of a display unit,
wherein the in-vehicle proxy server is operable to (1) modify the content acquired from the server such that a layout of the display information is changed to a changed layout adapted to the screen size of the display unit in accordance with the information indicating the screen size, and (2) supply the resultant modified content to the browser; and
the browser is operable to display the display information in the changed layout on the display unit in accordance with the modified content.

11. An in-vehicle display apparatus configured such that a browser requests that a server provide a content that includes display information and displays the display information included in the content provided from the server in response to the content request, the in-vehicle display apparatus comprising:
an in-vehicle proxy server operable to acquire the content provided from the server in response to the content request issued by the browser; and
an information providing unit operable to provide information indicating a running state of a vehicle to the in-vehicle proxy server,
wherein when the information indicating the running state indicates that the vehicle is currently running, the in-vehicle proxy server is operable to (1) modify the content such that a character size of the display information is increased so as to be greater than a character size for use in a state in which the vehicle is at rest, and (2) supply the resultant modified content to the browser; and
the browser is operable to display on a display unit the display information in the increased character size in accordance with the modified content.

12. The in-vehicle display apparatus according to claim 11, wherein the information indicating the running state of the vehicle is information generated based upon at least one of a vehicle speed pulse signal and a parking brake signal.

13. An in-vehicle display apparatus configured such that a browser requests that a server provide a content that includes one or more descriptions each specifying a linked content residing on a provider, requests that the provider provide a linked content in accordance with the content supplied from the server in response to the content request, and displays display information included in the linked content provided from the provider in response to the linked content request, the in-vehicle display apparatus comprising:
an in-vehicle proxy server operable to acquire the content provided from the server in response to the content request issued by the browser; and
an information providing unit operable to provide information indicating a type of information acceptable by the in-vehicle display apparatus to the in-vehicle proxy server,
wherein the in-vehicle proxy server is operable to (1) modify the content acquired from the server such that any description specifying a linked content that includes information of a type unacceptable by the in-vehicle display apparatus is deleted from the content in accordance with the information indicating the type of information acceptable by the in-vehicle display apparatus, and (2) supply the resultant modified content to the browser; and
the browser does not request the linked content that includes the information of the type unacceptable by the in-vehicle display apparatus in accordance with the modified content.

14. An in-vehicle proxy server for acquiring a content that is provided from a server in response to a request issued by a browser and that includes one or more descriptions each specifying a linked content that includes display information residing on a provider, the in-vehicle proxy server being configured such that:
the in-vehicle proxy server is operable to (1) acquire information indicating a running state of a vehicle, and (2) modify the content acquired from the server such that, in accordance with the information indicating the running state, any description specifying a linked content that includes display information not to be displayed on a display unit in the current vehicle running state is deleted from the content, and the resultant modified content is supplied to the browser thereby preventing the browser from requesting the linked content that includes the display information not to be displayed.

15. The in-vehicle proxy server according to claim 14, wherein when the acquired information indicating the running state indicates that the vehicle is currently running, the in-vehicle proxy server (1) modifies the content acquired from the server such that any description specifying a linked content that includes image information is deleted from the content, and (2) supplies the resultant modified content to the browser thereby preventing the browser from requesting the linked content that includes the image information.

16. The in-vehicle proxy server according to claim 15, wherein the image information is moving image information.

17. The in-vehicle proxy server according to claim 15, wherein the in-vehicle proxy server operates on both a first browser operable to display information on a first display located in the driver's seat area and a second browser operable to display information on a second display located in the rear seat area, and the in-vehicle proxy server is allowed to supply the content maintaining the description specifying the linked content that includes the image information to the second browser even when the vehicle is currently running, thereby allowing the second browser to request the linked content that includes the image information and display the image information on the second display.

18. The in-vehicle proxy server according to claim 14, wherein when the acquired information indicating the running state indicates that the vehicle is currently running at a speed higher than a predetermined speed, the in-vehicle proxy server (1) modifies the content acquired from the server such that the description specifying the linked content that includes image information is deleted from the content, and (2) supplies the resultant modified content to the browser thereby preventing the browser from requesting the linked content that includes the image information.

19. The in-vehicle proxy server according to claim 18, wherein the in-vehicle proxy server operates on both a first browser operable to display information on a first display located in the driver's seat area and a second browser operable to display information on a second display located in the rear seat area, and the in-vehicle proxy server is allowed to supply the content maintaining the description specifying the linked content that includes the image information to the second browser even when the vehicle is currently running at a speed higher than the predetermined speed, thereby allowing the second browser to request the linked content that includes the image information and display the image information on the second display.
